(19) United States
(12) Patent Application Publication
(10) Pub. No.: US 2024/0403397 A1
(43) Pub. Date: Dec. 5, 2024

(54) INFORMATION PROCESSING METHOD, INFORMATION PROCESSING DEVICE, AND NON-TRANSITORY COMPUTER READABLE STORAGE MEDIUM

(71) Applicant: Panasonic Intellectual Property Corporation of America, Torrance, CA (US)

(72) Inventors: Nobuaki TASAKI, Osaka (JP); Tatsumi NAGASHIMA, Osaka (JP)

(73) Assignee: Panasonic Intellectual Property Corporation of America, Torrance, CA (US)

(21) Appl. No.: 18/800,469

(22) Filed: Aug. 12, 2024

Related U.S. Application Data
(63) Continuation of application No. PCT/JP2022/040254, filed on Oct. 27, 2022.

(30) Foreign Application Priority Data
Feb. 15, 2022 (JP) 2022-021300

(51) Int. Cl. G06F 21/31; G06F 21/55

(52) U.S. Cl. CPC G06F 21/31; G06F 21/552; G06F 2221/034

(57) ABSTRACT

A server acquires a user ID proving a user to be an authenticated user for a vehicle and log data indicative of a use history of a storage battery associated with the user ID, estimates on the basis of the log data a fraudulent use rate of the vehicle by way of the user ID, and outputs a result of the estimation.

### FIELD OF INVENTION

The present disclosure relates to a technique for detecting a fraudulent use of an electric mover.

### BACKGROUND ART

In recent years, a service of providing a joint use of an electric mover have been on the increase. In these services, an electric mover is rented out to a user who has been authenticated as a user of the electric mover. Therefore, in a case that information for the authentication is stolen, the electric mover is liable to be fraudulently used by a user other than a legitimate user. Nevertheless, a fraudulent use of the electric mover is not detectable until the legitimate user informs of it.

Thus, for example, Patent Literature 1 discloses a technique for determining whether a target vehicle was fraudulently used or not with a classifier having learned to output, upon input of a use state of the vehicle and a use state of a battery mounted on the vehicle, whether the target vehicle was fraudulently used or not.

However, no consideration can be seen in the technique of Patent Literature 1 about a joint use of a vehicle by a plurality of users.

Patent Literature 1: International Unexamined Patent Publication No. 2020/240619

### SUMMARY OF THE INVENTION

The present disclosure has been made in order to solve the problem described above, and an object thereof is to provide a technique that enables an early detection of a user subjected to a fraudulent use of an electric mover.

An information processing method according to an aspect of the present disclosure is an information processing method for detecting a fraudulent use of an electric mover driven by an electric power of a battery, by a computer, and includes acquiring a user ID proving a user to be an authenticated user for the electric mover and log data indicative of a use history of the battery associated with the user ID, estimating on the basis of the log data a fraudulent use rate of the electric mover by way of the user ID, and outputting a result of the estimation.

### BRIEF DESCRIPTION OF THE DRAWINGS

FIG. 1 is a diagram showing a general configuration of an information processing system according to an embodiment of the present disclosure.

FIG. 2 is a diagram showing an exemplary configuration of a vehicle.

FIG. 3 is a diagram showing an exemplary configuration of a server.

FIG. 4 is a table showing exemplary record groups stored in a log storage part.

FIG. 5 is a diagram showing an exemplary configuration of an information terminal.

FIG. 6 is a flowchart showing an exemplary fraudulent use rate estimation process.

FIG. 7 is an illustration showing a first exemplary output of fraudulent use rates of the vehicle.

FIG. 8 is a graph showing an exemplary time-series change in discharge current indicated by log data.

FIG. 9 is an illustration showing a second exemplary output of the fraudulent use rate of the vehicle.

FIG. 10 is an illustration showing a third exemplary output of the fraudulent use rate of the vehicle.

### DETAILED DESCRIPTION

### Knowledge Underlying the Present Disclosure

In recent years, there has been an increase in a service of providing a joint use of an electric mover, e.g., an electric car, an electric bicycle, an electric motorcycle, and an electric kickboard, which is driven by an electric power of a battery. In this service, whether a user has been authenticated for the electric mover is carried out on the basis of authentication information, e.g., a user ID which is stored in an IC card or is input to a dedicated application. Thereafter, the electric mover is rented out to a user who has been authenticated for the electric mover.

Therefore, if the authentication information is stolen, there is the likelihood that the electric mover is fraudulently used by a user other than the legitimate user. Consequently, there is the likelihood that a rental fee higher than regular one is charged to the legitimate user of the electric mover. Nevertheless, a fraudulent use of the electric mover is not detectable until the legitimate user informs of it.

No consideration can be seen in the technique of Patent Literature 1 about a joint use of a vehicle by a plurality of users. Consequently, in a case that a target vehicle is used by a legitimate user having few occasions to use the target vehicle, the use is liable to be mistakenly judged as a fraudulent use of the target vehicle due to a huge difference in use states of the target vehicle and a battery thereof from those during the use by another legitimate user.

(1) In order to solve the problem described above, an information processing method according to an aspect of the present disclosure is an information processing method for detecting a fraudulent use of an electric mover driven by an electric power of a battery, by a computer, and includes acquiring a user ID proving a user to be an authenticated user for the electric mover and log data indicative of a use history of the battery associated with the user ID, estimating on the basis of the log data a fraudulent use rate of the electric mover by way of the user ID, and outputting a result of the estimation.

In this configuration, a fraudulent use rate of the electric mover by way of the user ID is estimated on the basis of log data indicative of a use history of a battery associated with the user ID, and a result of the estimation is output, which makes it possible to grasp whether the electric mover was fraudulently used by way of the user ID. This enables an early detection of a user who is subjected to a fraudulent use of the electric mover.

(2) In the information processing method recited in the above-mentioned (1), the use history of the battery may include at least one of a first time-series change indicating a time-series change in the electric current discharged from the battery in an acceleration of the electric mover and a second time-series change indicating a time-series change in the decrease electric current discharged from the battery in a deceleration of the electric mover.

This configuration makes it possible to accurately estimate the fraudulent use rate of the electric mover by way of the user ID on the basis of at least one of the first time-series change and the second time-series change, which are likely to reflect the user's tendencies in the use of the battery included in the log data.

(3) In the information processing method recited in the above-mentioned (1) or (2), in the estimation of the fraudulent use rate of the electric mover, the fraudulent use rate of the electric mover by way of the user ID may be estimated by inputting the log data to a learned model having learned a relationship between the use history of the battery and a use rate of the electric mover by a user other than the authenticated user of the user ID.

In this configuration, upon an input of the log data to the learned model, a result of the estimation of the fraudulent use rate of the electric mover by way of the user ID is output, which makes it possible to accurately grasp whether the electric mover was fraudulently used by way of the user ID.

(4) Further, in the information processing method recited in the above-mentioned (2), in the estimation of the fraudulent use rate of the electric mover, the fraudulent use rate of the electric mover by way of the user ID may be estimated on the basis of an average of the electric current in a predetermined period specified by the first time-series change included in the log data.

This configuration makes it possible to accurately estimate the fraudulent use rate of the electric mover by way of the user ID on the basis of the average of the electric current in the predetermined period specified by the first time-series change included in the log data.

(5) Further, in the information processing method recited in the above-mentioned (2), in the estimation of the fraudulent use rate of the electric mover, the fraudulent use rate of the electric mover by way of the user ID may be estimated on the basis of an average of the decrease electric current in a predetermined period specified by the second time-series change included in the log data.

This configuration makes it possible to accurately estimate the fraudulent use rate of the electric mover by way of the user ID on the basis of the average of the decrease in the predetermined period specified by the second time-series change included in the log data.

(6) Further, in the information processing method recited in the above-mentioned (2), it may be appreciated that, in the estimation of the fraudulent use rate of the electric mover, in a case that the use history of the battery includes the first time-series change, a first fraudulent use rate of the electric mover by way of the user ID is estimated by inputting data specifying the first time-series change included in the log data to a first learned model having learned a relationship between the first time-series change and a use rate of the electric mover by a user other than the authenticated user of the user ID, in a case that the use history of the battery includes the second time-series change, a second fraudulent use rate of the electric mover by way of the user ID is estimated by inputting data specifying the second time-series change included in the log data to a second learned model having learned a relationship between the second time-series change and a use rate of the electric mover by a user other than the authenticated user of the user ID, and a weighted average of the first fraudulent use rate and the second fraudulent use rate is estimated as the fraudulent use rate of the electric mover by way of the user ID.

In this configuration, a weighted average of the first fraudulent use rate of the electric mover by way of the user ID, which was estimated using the first learned model based on the first time-series change, and the second fraudulent use rate of the electric mover by way of the user ID, which was estimated using the second learned model based on the second time-series change, is estimated as the fraudulent use rate of the electric mover by way of the user ID. Therefore, the fraudulent use rate of the electric mover by way of the user ID can be accurately estimated by taking into account user's tendencies in the use of the battery which are exhibited in the acceleration and the deceleration of the electric mover, respectively.

(7) Further, the information processing method recited in the above-mentioned (1) may further include acquiring feature data indicating a geographic feature of a travel route of the electric mover in a period corresponding to the use history of the battery indicated by the log data, wherein, in the estimation of the fraudulent use rate of the electric mover, the fraudulent use rate of the electric mover by way of the user ID may be estimated by inputting the log data and the feature data to a third learned model having learned a relationship among the use history of the battery, the geographic feature of the travel route of the electric mover in the period corresponding to the use history, and a use rate of the electric mover by a user other than the authenticated user of the user ID.

This configuration makes it possible to accurately estimate the fraudulent use rate of the electric mover by way of the user ID by further taking into account the geographic feature of the travel route of the electric mover in the period corresponding to the use history of the battery.

(8) Further, in the information processing method recited in the above-mentioned (7), the geographic feature may include at least one of a speed limit and a road width.

This configuration makes it possible to accurately estimate the fraudulent use rate of the electric mover by way of the user ID by further taking into account at least one of the speed limit and the road width of the travel route of the electric mover in the period corresponding to the use history of the battery.

(9) Further, the information processing method recited in the above-mentioned (1) may further include acquiring traffic congestion data indicative of a level of a traffic congestion occurred on a travel route of the electric mover in a period corresponding to the use history of the battery indicated by the log data, wherein, in the estimation of the fraudulent use rate of the electric mover, the fraudulent use rate of the electric mover by way of the user ID may be estimated by inputting the log data and the traffic congestion data to a fourth learned model having learned a relationship among the use history of the battery, the level of the traffic congestion occurred on the travel route of the electric mover in the period corresponding to the use history, and a use rate of the electric mover by a user other than the authenticated user of the user ID.

This configuration makes it possible to accurately estimate the fraudulent use rate of the electric mover by way of the user ID by further taking into account the level of the traffic congestion occurred on the travel route of the electric mover in the period corresponding to the use history of the battery.

(10) Additionally, the information processing method recited in the above-mentioned (1) may further include acquiring operation log data indicative of an operation history of the electric mover in a period corresponding to the use history of the battery indicated by the log data, wherein, in the estimation of the fraudulent use rate of the electric mover, the fraudulent use rate of the electric mover by way of the user ID may be estimated by inputting the log data and the operation log data to a fifth learned model having learned a relationship among the use history of the battery, the operation history of the electric mover in the period corresponding to the use history, and a use rate of the electric mover by a user other than the authenticated user of the user ID.

This configuration makes it possible to accurately estimate the fraudulent use rate of the electric mover by way of the user ID by further taking into account the operation history of the electric mover in the period corresponding to the use history of the battery.

(11) Further, in the information processing method recited in the above-mentioned (10), the operation history of the electric mover may include at least one of histories of an accelerating operation, a steering operation, a braking operation, a travel speed, an acceleration, and an angular velocity.

This configuration makes it possible to accurately estimate the fraudulent use rate of the electric mover by way of the user ID by further taking into account at least one of the histories of the accelerating operation, the steering operation, the braking operation, the travel speed, the acceleration, and the angular velocity of the electric mover in the period corresponding to the use history of the battery.

(12) Further, in the information processing method recited in any one of the above-mentioned (1) to (11), in the output of the result of the estimation, the user ID and the estimated fraudulent use rate of the electric mover by way of the user ID may be output in association with each other to a first information terminal used by a manager of the electric mover.

In this configuration, the user ID and the fraudulent use rate of the electric mover by way of the user ID are output in association with each other to the first information terminal used by the manager of the electric mover. This enables the manager to easily grasp whether the electric mover was fraudulently used or not by way of the user ID.

(13) Further, the information processing method recited in the above-mentioned (12) may include estimating, in a case that the estimated fraudulent use rate of the electric mover by way of the user ID is equal to or higher than a predetermined threshold and the authenticated user of the user ID belongs to a group including a plurality of users, a fraudulent use rate of the electric mover by each of one or more users who belong to the group but are other than the authenticated user of the user ID by inputting the log data to a sixth learned model having learned a relationship between the use history of the battery and a use rate of the electric mover by a user different from the users of the group, wherein, in the output of the result of the estimation, at least one of the fraudulent use rates of the electric mover by the one or more users of the group may be further output in association with the user ID.

In this configuration, in association with a user ID by way of which an electric mover is estimated to be fraudulently used at a rate equal to or higher than a predetermined threshold, at least one of fraudulent use rates of the electric mover by one or more users of the group including the authenticated user of the user ID is output to the first information terminal. This enables the manager to grasp whether a user belonging to the same group as the authenticated user of the user ID fraudulently used the electric mover by way of the user ID or not.

(14) Further, in the information processing method recited in the above-mentioned (13), in the output of the result of the estimation, a lowest one among the fraudulent use rates of the electric mover by the one or more users of the group may be output in association with the user ID.

In this configuration, in association with the user ID by way of which the electric mover is estimated to be fraudulently used at the rate equal to or higher than the predetermined threshold, the lowest one among the fraudulent use rates of the electric mover by each of the users of the group including the authenticated user of the user ID is output to the first information terminal. This enables the manager to grasp whether a user belonging to the same group as the authenticated user of the user ID fraudulently used the electric mover by way of the user ID or not.

(15) Further, in the information processing method recited in any one of the above-mentioned (1) to (11), in the output of the result of the estimation, in a case that the estimated fraudulent use rate of the electric mover by way of the user ID is equal to or higher than a predetermined threshold, information indicative of a fraudulent use of the electric mover may be output to a second information terminal used by the authenticated user of the user ID.

This configuration enables the authenticated user of the user ID to grasp that the electric mover was fraudulently used by way of his/her own user ID with reference to the information indicative of the fraudulent use of the electric mover which is output to the second information terminal.

(16) An information processing device according to another aspect of the present disclosure is an information processing device for detecting a fraudulent use of an electric mover driven by an electric power of a battery, and includes an acquisition part that acquires a user ID proving a user to be an authenticated user for the electric mover and log data indicative of a use history of the battery associated with the user ID, an estimation part that estimates on the basis of the log data a fraudulent use rate of the electric mover by way of the user ID, and an output part that outputs a result of the estimation.

According to this configuration, the same advantageous effects as the information processing method described in the above-mentioned (1) can be obtained.

(17) A non-transitory computer readable storage medium according to still another aspect of the present disclosure is a non-transitory computer readable storage medium storing a control program of an information processing device for detecting a fraudulent use of an electric mover driven by an electric power of a battery, the control program causing a computer included in the information processing device to function as: an acquisition part that acquires a user ID proving a user to be an authenticated user for the electric mover and log data indicative of a use history of the battery associated with the user ID; an estimation part that estimates on the basis of the log data a fraudulent use rate of the electric mover by way of the user ID; and an output part that outputs a result of the estimation.

According to this configuration, the same advantageous effects as the information processing method described in the above-mentioned (1) can be obtained.

Hereinafter, an embodiment of the present disclosure will be described with reference to the accompanied drawings. It should be noted that the below-described embodiment is a specific example of the present disclosure and will not delimit the technical scope of the present disclosure.

### Embodiment

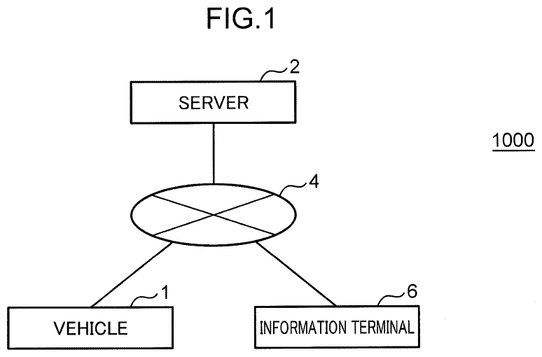

FIG. 1 is a diagram showing a general configuration of an information processing system 1000 according to an embodiment of the present disclosure. The information processing system 1000 includes a vehicle (electric mover) 1, a server (information processing device) 2, and an information terminal (first information terminal, second information terminal) 6.

The vehicle 1 is provided with a storage battery which is chargeable and dischargeable. The vehicle 1 is an electric vehicle driven through supply of an electric power stored in the storage battery to an electric motor. The vehicle 1 includes, for example, an electric car, an electric truck, an electric motorcycle, an electric bicycle, or an electric kickboard. The vehicle 1 is rented out to an authenticated user for the vehicle 1.

The vehicle 1 is mutually communicably connected to the server 2 via a network 4. The network 4 includes, for example, Internet. The vehicle 1 periodically sends to the server 2 log data indicative of use state of the storage battery mounted on the vehicle 1. Details on the log data will be described later.

The server 2 includes, for example, a cloud server. The server 2 is mutually communicably connected to the vehicle 1 and the information terminal 6 via the network 4. The server 2 receives various information such as log data from the vehicle 1. The server 2 estimates a fraudulent use rate of the vehicle 1 on the basis of the log data received from the vehicle 1, and sends information concerning an estimation result to the information terminal 6.

The information terminal 6 is an information processing terminal, e.g., a smartphone, a tablet terminal, and/or a laptop computer, which is used by a manager of the information processing system 1000 or a user of the vehicle 1. The information terminal 6 communicates various information with an external device such as the vehicle 1 and the server 2 via the network 4. The information terminal 6 includes a display device such as a liquid crystal display and a touchscreen device. The information terminal 6 causes the display device to display information received from the external device and a certain operation screen. The information terminal 6 sends to the external device information which is input by the user on the operation screen using the touchscreen device.

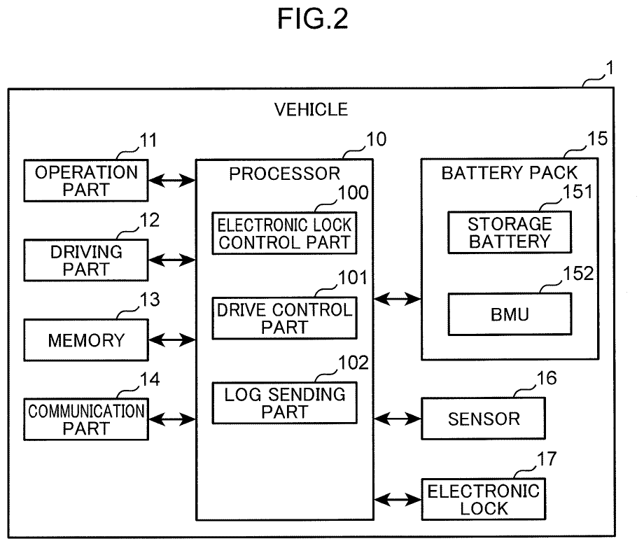

FIG. 2 is a diagram showing an exemplary configuration of the vehicle 1. The vehicle 1 includes an operation part 11, a driving part 12, a memory 13, a communication part 14, a battery pack 15, a sensor 16, an electronic lock 17, and a processor 10.

The operation part 11 includes, for example, a steering wheel, a gear lever, an accelerator pedal, and a brake pedal, and receives a driving operation of the vehicle 1 by a driver by use of these.

Further, the operation part 11 includes, for example, an IC card reader, and receives an unlocking operation of the vehicle 1 by use of the same. Specifically, when an IC card is placed in proximity to the IC card reader in such a manner as to face a certain reading surface of the IC card reader, or the IC card is inserted in a certain insertion slot, the IC card reader reads authentication information stored in a memory embedded in the IC card. The authentication information includes information (hereinafter, user ID) of identifying a user and information (hereinafter, group ID) of identifying a group to which the user belongs. The group is composed of a plurality of users. The group includes, for example, a family or a workplace (department, section). The authentication information may not include a group ID, for example, in a case that the user does not belong to any group.

When the authentication information is read by the IC card reader, the operation part 11 receives the unlocking operation of the vehicle 1 by an authenticated user (hereinafter, authenticated user of the user ID) of the user ID included in the authentication information, and outputs the authentication information to the processor 10.

Further, the operation part 11 includes, for example, a lock button, and receives a locking operation of the vehicle 1 when the lock button is pressed.

The driving part 12 includes, for example, an inverter, an electric motor, and a transmission, and drives the vehicle 1 by an electric power of a storage battery 151 in accordance with a control by a drive control part 101.

The memory 13 includes, for example, a storage device, e.g., RAM (Random Access Memory), SSD (Solid State Drive), or Flash Memory, which is capable of storing a variety of information. For example, the memory 13 stores information (hereinafter, vehicle ID) of identifying the vehicle 1.

The communication part 14 is a communication interface circuit adapted to send and receive a variety of information to and from an external device such as the server 2 via the network 4.

The battery pack 15 includes the storage battery 151 and a BMU (Battery Management Unit) 152.

The storage battery 151 is, for example, a secondary battery such as a lithium-ion battery which is chargeable and dischargeable. The storage battery 151 is charged with an electric power caused by a regenerative energy in the driving part 12 or an electric power supplied from an unillustrated charging-discharging device via a charge cable. The electric power stored in the storage battery 151 is used in the driving part 12.

The BMU 152 includes, for example, a microcomputer provided with, e.g., a processor, a non-volatile memory such as RAM (Random Access Memory) and ROM (Read Only Memory), an input/output circuit, a timer circuit, and various measurement circuits. The various measurement circuits include measurement circuits for measuring an electric current (hereinafter, discharge current) discharged from the storage battery 151, a voltage, and a temperature of the storage battery 151, respectively.

The BMU 152 measures, for example, a use state of the storage battery 151 periodically, e.g., every ten seconds, and stores log data indicative of a result of the measurement in the non-volatile memory inside the BMU 152. For example, the log data includes information (hereinafter, date and time information) indicative of a date and time at which the use state of the storage battery 151 is measured and information (hereinafter, use state information) indicative of a measurement result of the use state of the storage battery 151. The use state of the storage battery 151 includes discharge current, voltage, and temperature of the storage battery 151. However, the use state of the storage battery 151 is not limited thereto.

The sensor 16 is a sensor which detects an operation state of the vehicle 1. The operation state of the vehicle 1 includes an accelerating operation (depression amount, depression speed and frequency of an accelerator pedal), a braking operation (depression amount, depression speed and frequency of a brake pedal), and a steering operation (rotation amount and rotation speed of a steering wheel).

Further, the operation state of the vehicle 1 includes a location (for example, latitude and longitude) of the vehicle 1, the travel speed (hereinafter, vehicle speed), an acceleration and an angular velocity of the vehicle 1. The acceleration indicates, for example, an acceleration toward at least one direction among lateral (X-axis) direction, longitudinal (Y-axis) direction, and vertical (Z-axis) direction of the vehicle 1. The angular velocity indicates an angular velocity about at least one axis among angular velocities about three axes respectively extending in the lateral direction, the longitudinal direction, and the vertical direction of the vehicle 1. However, the operation state of the vehicle 1 is not limited thereto. The sensor 16 outputs information indicative of the detected operation state of the vehicle 1 to the processor 10.

The electronic lock 17 electrically locks and unlocks the vehicle 1. The electronic lock 17 may electrically lock and unlock a door of the vehicle 1 which is an electric car or an electric truck, and concurrently electrically lock and unlock a key box which is provided inside the vehicle 1 and contains a physical key of the vehicle 1.

The processor 10 includes, for example, a CPU (Central Processing Unit). The processor 10 performs a control program stored in the memory 13 to thereby serve as an electronic lock control part 100, the drive control part 101, and a log sending part 102.

The electronic lock control part 100 controls locking and unlocking of the electronic lock 17.

Specifically, when the operation part 11 receives an unlocking operation, the electronic lock control part 100 controls the communication part 14 to thereby send to the server 2 information (hereinafter, unlocking request information) which requests the unlocking of the electronic lock 17. The unlocking request information includes the authentication information which is input from the operation part 11 when receiving the unlocking operation and a vehicle ID which is stored in the memory 13.

After sending the unlocking request information, the communication part 14 receives from the server 2 information (hereinafter, unlocking permission information) indicative of a permission to unlock the electronic lock 17. In response thereto, the electronic lock control part 100 unlocks the electronic lock 17, and stores the authentication information included in the unlocking request information in the memory 13. In other words, the user ID included in the authentication information stored in the memory 13 is an exemplary user ID of an authenticated user for the electric mover of the present disclosure.

When the operation part 11 receives a locking operation, the electronic lock control part 100 locks the electronic lock 17, and deletes the authentication information stored in the memory 13.

The drive control part 101 controls the driving part 12 in accordance with a drive operation of the user via the operation part 11 to thereby cause the vehicle 1 to travel.

For example, when the user performs an operation of depressing the accelerator pedal, the drive control part 101 supplies the electric power in the storage battery 151 to the driving part 12 to thereby rotate an electric motor. The electric power in the storage battery 151 is thus discharged to the electric motor.

When the user performs an operation of depressing the brake pedal, the drive control part 101 causes the driving part 12 to reduce a rotational speed of the electric motor. Accordingly, the electric power discharged from the storage battery 151 to the electric motor decreases, which results in a regenerative energy in the electric motor. The driving part 12 converts the regenerative energy to an electric power, and supplies this electric power to the storage battery 151. The storage battery 151 is thus charged with the electric power. The driving part 12 may be configured not to convert the regenerative energy to an electric power.

During a travel in the vehicle 1, the drive control part 101 periodically (e.g., every ten seconds) causes the sensor 16 to detect an operation state of the vehicle 1, and stores in the memory 13 information indicative of the detected operation state of the vehicle 1 in association with a current date and time. For example, the information indicative of the operation state of the vehicle 1 includes information (hereinafter, location information) indicative of a location of the vehicle 1. Further, the information indicative of the operation state of the vehicle 1 includes information indicative of at least one of an accelerating operation, a braking operation, a steering operation, a vehicle speed, an acceleration, and an angular velocity of the vehicle 1. Hereinafter, information indicative of the operation state of the vehicle 1 is referred to as vehicle operation information. During a travel in the vehicle 1 indicates a period since the vehicle 1 starts moving until the vehicle 1 remains stationary continuously for a certain duration or longer.

During the travel in the vehicle 1, the log sending part 102 periodically (e.g., every ten seconds) acquires log data stored in the non-volatile memory inside the BMU 152, authentication information and a vehicle ID which are stored in the memory 13, and vehicle operation information associated with a date and time indicated by the date and time information included in the log data which is stored in the memory 13, and sends these to the server 2 using the communication part 14.

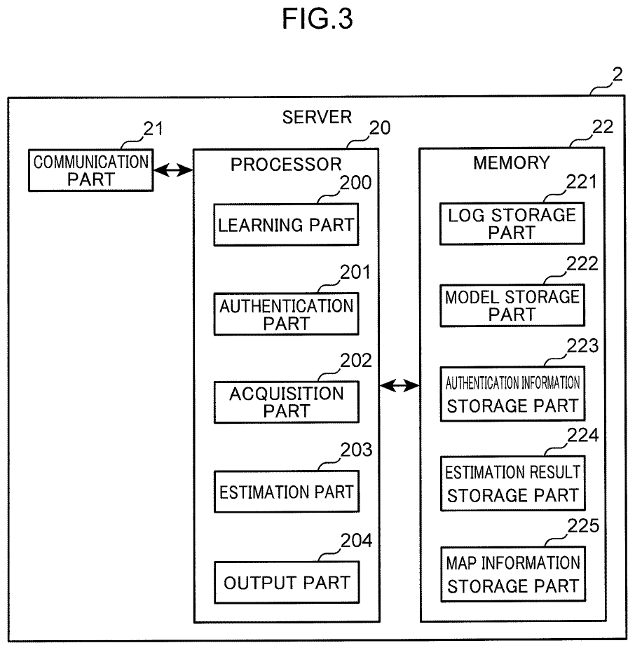

FIG. 3 is a diagram showing an exemplary configuration of the server 2. The server 2 includes a communication part 21, a memory 22, and a processor (computer) 20.

The communication part 21 is a communication interface circuit which sends and receives various information to and from the vehicle 1 and an external device such as the information terminal 6 via the network 4. For example, when receiving the log data, the authentication information, the vehicle ID, and the vehicle operation information from the vehicle 1, the communication part 21 outputs these to the processor 20. Further, the communication part 21 sends information concerning an estimation result of a fraudulent use rate of the vehicle 1 to the information terminal 6 under the control of the processor 20.

The memory 22 is, for example, a storage device such as RAM, HDD (Hard Disk Drive), SSD, or Flash Memory, which is capable of storing a variety of information. The memory 22 stores a control program executed by the processor 20. Further, the log storage part 221, a model storage part 222, an authentication information storage part 223, an estimation result storage part 224, and a map information storage part 225 are configured in the memory 22.

The log storage part 221 stores a record group in which log data received by the communication part 21 from the vehicle 1 is associated with authentication information, a vehicle ID, and vehicle operation information which are received together with the log data.

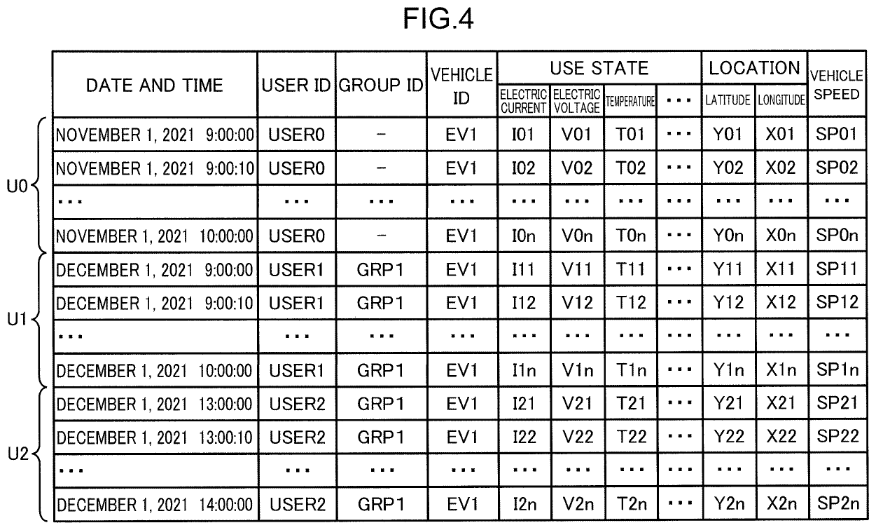

FIG. 4 is a table showing an exemplary record group stored in the log storage part 221. For example, a reference sign U0 in FIG. 4 indicates a record group which is stored in a case of a use of a vehicle 1 of a vehicle ID “EV1” by a user of a user ID “USER0” from 9 o'clock to 10 o'clock on Nov. 1, 2021. Hereinafter, the record group is called as a record group U0.

For convenience of explanation, FIG. 4 shows an example where location information and information indicative of a vehicle speed of the vehicle 1 are stored in the log storage part 221 as the vehicle operation information. The log storage part 221 is not limited thereto, but may store location information included in the vehicle operation information and at least one piece of information among pieces of information respectively indicative of an accelerating operation, a steering operation, a braking operation, a travel speed, an acceleration, and an angular velocity which are included in the vehicle operation information.

A reference sign U1 in FIG. 4 indicates a record group which is stored in a case of a use of the vehicle 1 of the vehicle ID “EV1” by a user of a user ID “USER1” belonging to a group of a group ID “GRP1” from 9 o'clock to 10 o'clock on Dec. 1, 2021. Hereinafter, the record group is called as a record group U1. A reference sign U2 in FIG. 4 indicates a record group which is stored in a case of a use of the vehicle 1 of the vehicle ID “EV1” by a user of a user ID “USER2” belonging to the group of the group ID “GRP1” from 13 o'clock to 14 o'clock on Dec. 1, 2021. Hereinafter, the record group is called as a record group U2.

The model storage part 222 stores fraudulent use rate estimation models corresponding to respective user IDs of users managed by the information processing system 1000. The fraudulent use rate estimation model corresponding to one user ID is a learned model which has learned a relationship between a history (hereinafter, use history) of a use state of the storage battery 151 of the vehicle 1 and a use rate of the vehicle 1 by a user other than an authenticated user of the one user ID. The fraudulent use rate estimation model corresponding to the one user ID outputs, in a case that log data corresponding to (associated with) the one user ID is input thereto, a fraudulent use rate of the vehicle 1 by way of the one user ID.

The log data corresponding to the one user ID indicates log data stored in the log storage part 221 in association with the one user ID. In the example shown in FIG. 4, the log data associated with the user ID “USER1” indicates log data (“date and time” and “use state”) included in the record group U1.

The fraudulent use rate of the vehicle 1 by way of the one user ID indicates a rate at which the vehicle 1 was fraudulently used by a user different from the authenticated user of the one user ID in a state where the authenticated user of the one user ID is determined to be the user of the vehicle 1.

The authentication information storage part 223 stores various information for determining whether the authenticated user of the user ID included in the authentication information received by the communication part 21 is the user of the vehicle 1 or not.

Specifically, the authentication information storage part 223 stores information (hereinafter, user information) concerning a user managed by the information processing system 1000 and information (hereinafter, vehicle information) concerning a vehicle 1 managed by the information processing system 1000. The user information includes a user ID, a password, a group ID, and contact information of the user. The contact information of the user includes, for example, an e-mail address, an account of a social networking service used by the user, and/or an IP address of an information terminal 6 used by the user. The vehicle information includes a vehicle ID and a type and a plate number of the vehicle 1.

The estimation result storage part 224 stores information concerning an estimation result by an estimation part 203 to be described later.

The map information storage part 225 stores a map image of a predetermined region and information indicative of respective geographic features of a plurality of roads included in the predetermined region. A geographic feature of one road includes at least one of a speed limit and a road width of the one road. The geographic feature of the one road is not limited to the speed limit and the road width of the one road, but may include, for example, a degree of slope of the one road and/or the number of roads crossing the one road (number of junctions).

The processor 20 includes, for example, a CPU. The processor 20 implements a control program stored in the memory 22 to thereby serve as a learning part 200, an authentication part 201, an acquisition part 202, an estimation part 203, and an output part 204.

The learning part 200 creates the fraudulent use rate estimation models corresponding to the respective user IDs at a desired time, e.g., once a month. The learning part 200 stores the created fraudulent use rate estimation models corresponding to the respective user IDs in the model storage part 222.

The fraudulent use rate estimation models corresponding to the respective user IDs are created using log data stored in the log storage part 221 in a predetermined period when the vehicle 1 is used by a plurality of users. The predetermined period includes, for example, a one-month period from two months before to one month before a point in time at which the fraudulent use rate estimation model is created, or a one-month period until the point in time of the creation.

For example, the learning part 200 acquires from the log storage part 221 (FIG. 4) as first log data a piece of log data associated with one of the user IDs (e.g., USER1) among pieces of log data including date and time information falling within the predetermined period (e.g., one-month period of December 2021). Further, the learning part 200 acquires from the log storage part 221 as second log data a piece of log data associated with a user ID (e.g., USER2) other than the one user ID among the pieces of log data including date and time information falling within the predetermined period.

Further, the learning part 200 creates the fraudulent use rate estimation model corresponding to the one user ID by performing a machine learning of a relationship between use histories of the storage battery 151 indicated by the first log data and the second log data and a use rate of the vehicle 1 by a user other than the authenticated user of the one user ID using a predetermined learning algorithm.

Specifically, the learning part 200 performs a machine learning by using the use history of the storage battery 151 indicated by the first log data as an explanatory variable and a use rate of the vehicle 1 by a user other than a user of the one user ID when the first log data is acquired, i.e., 0%, as a target variable. Further, the learning part 200 performs a machine learning by using the use history of the storage battery 151 indicated by the second log data as the explanatory variable and a use rate of the vehicle 1 by a user other than a user of the one user ID when the second log data is acquired, i.e., 100%, as the target variable.

It may be appreciated that without using the processor 20 as the learning part 200, fraudulent use rate estimation models corresponding to the respective user IDs created in an information processing device or the like other than the server 2 are stored in advance in the model storage part 222.

If the communication part 21 receives unlocking request information from the vehicle 1 in response to an unlocking operation performed in the vehicle 1, the authentication part 201 acquires authentication information and a vehicle ID included in the unlocking request information. The authentication part 201 determines whether the authenticated user of the user ID included in the authentication information is the user of the vehicle 1 of the vehicle ID on the basis of the user information and the vehicle information stored in the authentication information storage part 223.

For example, in a case that the user ID included in the authentication information is included in the user information stored in the authentication information storage part 223 and the vehicle ID received from the vehicle 1 is included in the vehicle information stored in the authentication information storage part 223, the authentication part 201 determines that the authenticated user of the user ID included in the authentication information is the user of the vehicle 1 of the vehicle ID.

In the case that the authentication part 201 determines that the authenticated user of the user ID included in the authentication information is the user of the vehicle 1 of the vehicle ID, the authentication part 201 returns unlocking permission information to the vehicle 1 of the vehicle ID via the communication part 21. On the other hand, in a case that the authentication part 201 determines that the authenticated user of the user ID included in the authentication information is not the user of the vehicle 1 of the vehicle ID, the authentication part 201 returns information indicative of non-permission of the unlocking of the electronic lock 17 to the vehicle 1 of the vehicle ID via the communication part 21.

The authentication way by the authentication part 201 is not limited thereto, but a known authentication way may be properly adopted. The authentication information and contents of information stored in the authentication information storage part 223 may be properly changed according to the known authentication way to be adopted.

The acquisition part 202 acquires log data received by the communication part 21 from the vehicle 1 and the vehicle ID, the authentication information, and the vehicle operation information which are received by the communication part 21 together with the log data, and stores in the log storage part 221 a record in which these are associated with one another.

The estimation part 203 inputs pieces of log data respectively associated with the user IDs to the fraudulent use rate estimation models corresponding to the respective user IDs stored in the model storage part 222 to thereby estimate fraudulent use rates of the vehicle 1 by way of the respective user IDs.

For example, in a case that the record groups U0 to U2 shown in FIG. 4 are stored in the log storage part 221, the estimation part 203 inputs the log data included in the record group U0 stored in the log storage part 221 during the use of the vehicle 1 by the user of the user ID “USER0” to the fraudulent use rate estimation model corresponding to the user ID “USER0”. Accordingly, the estimation part 203 estimates a fraudulent use rate output from the fraudulent use rate estimation model as the fraudulent use rate of the vehicle 1 by way of the user ID “USER0”.

The output part 204 stores information concerning an estimation result by the estimation part 203 in the estimation result storage part 224. The information concerning an estimation result includes fraudulent use rates of the vehicle 1 by way of the respective user IDs estimated by the estimation part 203. Further, the information concerning an estimation result includes information based on the respective pieces of log data input to the fraudulent use rate estimation models corresponding to the respective user IDs by the estimation part 203. The information based on one piece of log data includes information (hereinafter, use date and time information) indicative of a period corresponding to the log data, a user ID, a group ID, a vehicle ID, and location information associated with the log data in the log storage part 221.

Further, the output part 204 adds contact information of the user of the one user ID and a vehicle type and a plate number of the vehicle 1 to the information concerning an estimation result with reference to the user information and the vehicle information stored in the authentication information storage part 223.

Further, the output part 204 sends (outputs) the information concerning an estimation result stored in the estimation result storage part 224 to the information terminal 6 via the communication part 21.

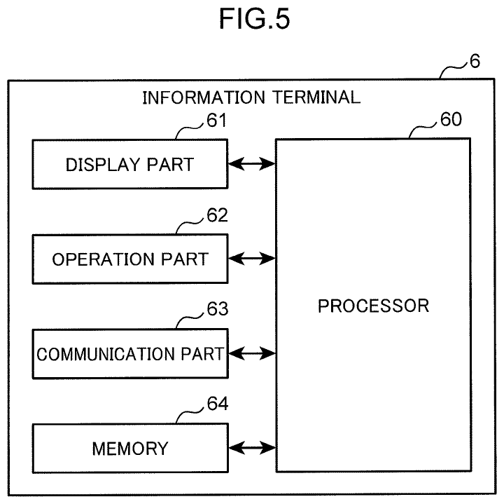

FIG. 5 is a diagram showing a configuration of an exemplary information terminal 6. As shown in FIG. 5, the information terminal 6 includes a display part 61, an operation part 62, a communication part 63, a memory 64, and a processor 60.

The display part 61 includes, for example, a display device such as a liquid crystal display device, and displays various information. The operation part 62 includes, for example, a touch screen, and receives various operations by the user. The communication part 63 includes a communication interface circuit which sends and receives various information from and to an external device such as the server 2 via the network 4. The memory 64 includes, for example, a storage device capable of storing a variety of information, e.g., RAM, HDD (Hard Disk Drive), SSD, or Flash Memory. The processor 60 includes, for example, a CPU, and controls the entire information terminal 6.

The information terminal 6 used by the user of the vehicle 1 may further include a camera or a barcode reader. The unlocking operation of the vehicle 1 may be performed in the information terminal 6.

Specifically, the processor 60 may receive an unlocking operation of the vehicle 1 when reading the vehicle ID of the vehicle 1 indicated by a barcode or a two-dimensional barcode attached to the vehicle 1 via the camera or the barcode reader. Further, the processor 60 may send to the server 2 the unlocking request information including the vehicle ID read from the barcode or the two-dimensional barcode and the authentication information which is input via the operation part 62 or is stored in advance in the memory 64.

Further, the information terminal 6 and the vehicle I used by the user of the vehicle 1 may include a communication interface circuit adapted for a short-range wireless communication. In this case, the processor 60 may receive the unlocking operation of the vehicle 1 when receiving the vehicle ID from the vehicle 1 via a short-range wireless communication by the information terminal 6 with the vehicle 1 in proximity to the information terminal 6.

Further, for example, in a case that the vehicle 1 is owned by the user and the vehicle 1 is paired in advance with the information terminal 6 used by the user, and therefore, the user ID of the user and the vehicle ID of the vehicle 1 are stored in advance in the memory 64 of the information terminal 6 in association with each other, it may be appreciated that the electronic lock control part 100 of the vehicle 1 sends unlocking request information to the information terminal 6 when the unlocking operation is received by the operation part 11, and the processor 60 of the information terminal 6 performs the same authentication as the authentication part 201 of the server 2 performs.

Hereinafter, a fraudulent use rate estimation process to be performed in the server 2 will be described. The fraudulent use rate estimation process is a process of estimating a fraudulent use rate of the vehicle 1 by way of each user ID on the basis of log data which is stored in the log storage part 221 and is associated with the user ID.

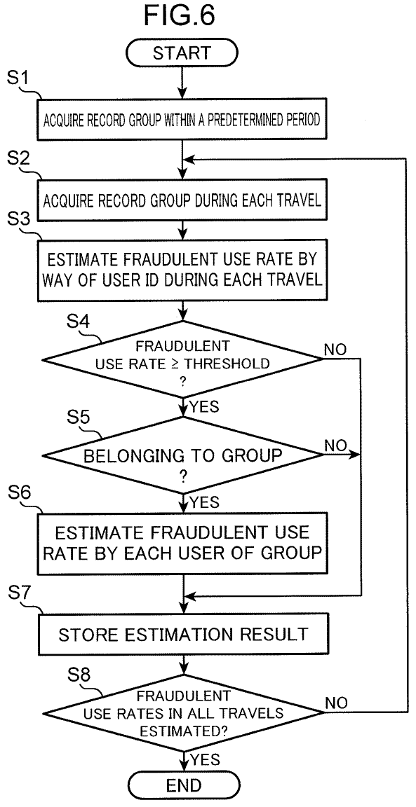

FIG. 6 is a flowchart showing an exemplary fraudulent use rate estimation process. The fraudulent use rate estimation process is performed at certain regular intervals, e.g., once a day.

First, in Step S1, the estimation part 203 acquires from the log storage part 221 record groups including date and times indicated by date and time information falling within a predetermined period. The predetermined period includes a period from an end of a previous fraudulent use rate estimation process to a start of the current fraudulent use rate estimation process.

Next, in Step S2, the estimation part 203 sequentially acquires record groups each corresponding to one travel in the vehicle 1 from the record groups acquired in Step S1, and performs the processes in Step S3 onwards using the acquired record groups. The record group corresponding to one travel in the vehicle 1 indicates a record group stored in the log storage part 221 from a start of a travel in the vehicle 1 to a completion of the travel.

Specifically, in Step S2, the estimation part 203 sequentially collates date and time information of the record groups acquired in Step S1. In a case that a lapse of time between a date and time indicated by previously collated date and time information and a date and time indicated by currently collated date and time information is longer than the interval at which the log sending part 102 sends the log data, the estimation part 203 acquires a record group including date and time information indicating a date and time earlier than the date and time indicated by the currently consulted date and time information as a record group corresponding to one travel in the vehicle 1. Further, the estimation part 203 deletes the acquired record group from the record groups acquired in Step S1.

Next, in Step S3, the estimation part 203 estimates a fraudulent use rate of the vehicle 1 by way of the user ID during the travel corresponding to the record group (hereinafter, target record group) acquired in Step S2.

Specifically, the estimation part 203 acquires the fraudulent use rate estimation model corresponding to the user ID included in the target record group from the model storage part 222. The estimation part 203 inputs log data included in the target record group to the fraudulent use rate estimation model to thereby estimate a fraudulent use rate of the vehicle 1 by way of the user ID during the travel corresponding to the record group.

Next, in Step S4, the estimation part 203 determines whether the fraudulent use rate estimated in Step S3 is equal to or higher than a predetermined threshold (e.g., 80%). In a case (YES in Step S4) that the estimation part 203 determines in Step S4 that the fraudulent use rate estimated in Step S3 is equal to or higher than the predetermined threshold, the estimation part 203 performs Step S5. On the other hand, in a case (NO in Step S4) that the estimation part 203 determines in Step S4 that the fraudulent use rate estimated in Step S3 is neither equal to nor higher than the predetermined threshold, the estimation part 203 performs Step S7.

In Step S5, the estimation part 203 determines whether the user (hereinafter, target user) of the user ID included in the target record group belongs to a group. Specifically, in a case that the target record group includes a group ID, the estimation part 203 determines in Step S5 that the target user belongs to a group.

In the case (YES in Step S5) that the estimation part 203 determines in Step S5 that the target user belongs to a group, in Step S6, the estimation part 203 estimates fraudulent use rates of the vehicle 1 by one or more users of the group who belong to the group including the target user but are other than the target user during the travel corresponding to the target record group.

Specifically, in Step S6, the estimation part 203 collates one or more pieces of user information which are stored in the authentication information storage part 223, include the group ID included in the target record group but do not include the user ID of the target user. The estimation part 203 acquires one or more user IDs included in the one or more pieces of user information as one or more group user IDs of identifying one or more users of the group who belong to the group including the target user but are other than the target user.

Further, the estimation part 203 estimates fraudulent use rates of the vehicle 1 by the one or more users of the group other than the target user during the travel corresponding to the target record group using the respective group user IDs of identifying the users of the group in the same manner as in Step S3.

Specifically, the estimation part 203 acquires fraudulent use rate estimation models (sixth learned models) respectively corresponding to the group user IDs from the model storage part 222. The estimation part 203 inputs pieces of log data included in the target record group to the respective fraudulent use rate estimation models to thereby estimate fraudulent use rates of the vehicle 1 by the users of the group of the respective group user IDs during the travel corresponding to the record group.

Next, in Step S7, the output part 204 stores information concerning an estimation result in Step S3 and Step S6 in the estimation result storage part 224.

Specifically, the information concerning an estimation result includes the fraudulent use rate of the vehicle 1 by way of the user ID during the travel corresponding to the target record group estimated in Step S3. Additionally, in the case that the Step S6 is performed, the output part 204 includes the lowest one among the fraudulent use rates of the vehicle 1 by the one or more users of the group estimated in Step S6 in the information concerning an estimation result.

Further, the information concerning an estimation result includes information based on log data included in the target record group input to the fraudulent use rate estimation model corresponding to each user ID in Step S3. The information based on log data includes, for example, use date and time information indicative of a period corresponding to the log data, a user ID, a group ID, and a vehicle ID associated with the log data. The period corresponding to the log data includes a period from the earliest date and time to the latest date and time among the date and times indicated by the date and time information included in the target record group. Further, the information based on log data includes location information associated with the log data and indicating a travel route of the vehicle 1 in the period corresponding to the log data.

Moreover, the output part 204 collates the user information and the vehicle information stored in the authentication information storage part 223 to thereby include contact information of the users of the respective user IDs, the type and the plate number of the vehicle 1 in the information concerning an estimation result.

In a case (YES in Step S8) that, in Step S3, the estimations of the respective fraudulent use rates of the vehicle 1 by way of the user IDs during all the travels in the vehicle 1 in the predetermined period are completed by using record groups corresponding to all the travels sequentially acquired in Step S2, the estimation part 203 terminates the fraudulent use rate estimation process. Alternatively (NO in Step S8), the estimation part 203 performs the processes in Step S2 onwards.

Hereinafter, an exemplary output of an estimation result by the estimation part 203 in an information terminal 6 will be described. In a case where, after the termination of the fraudulent use rate estimation process, the operation part 62 in an information terminal (first information terminal) 6 used by a manager of the information processing system 1000 receives a certain operation for displaying the estimation result by the manager, the processor 60 controls the communication part 63 to thereby send to the server 2 information (hereinafter, result request information) which requests a return of the information concerning an estimation result.

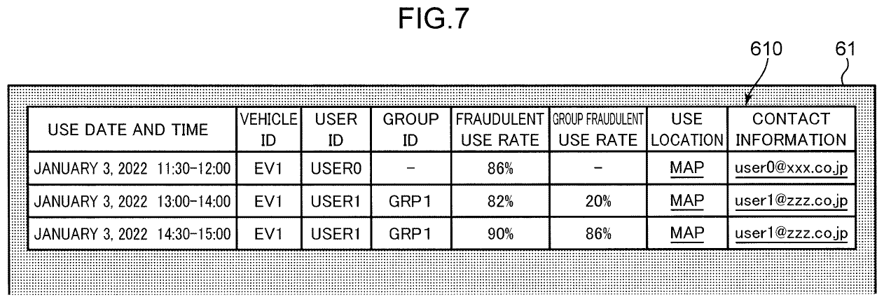

When the communication part 21 in the server 2 receives the result request information from the information terminal 6 used by the manager, the output part 204 returns the information concerning an estimation result stored in the estimation result storage part 224 to the information terminal 6 via the communication part 21. Accordingly, when the communication part 63 receives the information concerning an estimation result by the estimation part 203 from the server 2, the processor 60 controls the display part 61 to thereby display a screen image 610 shown in FIG. 7. FIG. 7 is a table showing a first exemplary output of fraudulent use rate of the vehicle 1.

On the screen image 610, the information concerning an estimation result received from the server 2 is displayed. For example, the screen image 610 in FIG. 7 shows an exemplary display of the information concerning an estimation result of the fraudulent use rate of the vehicle 1 by way of the user ID “USER1” in a case of a travel by the user of the user ID “USER1” in the vehicle 1 of the vehicle ID “EV1” “from 13:00 to 14:00 on Jan. 3, 2022”.

Specifically, use date and time information “from 13:00 to 14:00 on Jan. 3, 2022”, the user ID “USER1”, the group ID “GRP1” of the group including the user of the user ID “USER1”, and contact information “user1@zzz.co.jp” of the user of the user ID “USER1”, which are included in the information concerning an estimation result, are respectively displayed in a use date and time field, a user ID field, group ID and contact information fields.

In a fraudulent use rate field associated with the user ID “USER1”, a fraudulent use rate “82%” of the vehicle 1 of the vehicle ID “EV1” by way of the user ID “USER1” which is included in the information concerning an estimation result and is estimated in Step S3 is displayed.

The user of the user ID “USER1” belongs to the group of the group ID “GRP1”. Therefore, the information concerning an estimation result includes the lowest one “20%” among the respective fraudulent use rates of the vehicle 1 of the vehicle ID “EV1” by users of the group other than the user of the user ID “USER1” belonging to the group which are estimated in Step S6 (FIG. 6). In a group fraudulent use rate field associated with the user ID “USER1”, the lowest rate “20%” is displayed.

In a use location field associated with the user ID “USER1”, a hyperlink is displayed. The information concerning an estimation result includes location information indicative of a travel route of the vehicle 1 of the vehicle ID “EV1” in the period indicated by the use date and time information “from 13:00 to 14:00 on Jan. 3, 2022”. When the hyperlink is clicked, the processor 60 controls the display part 61 to further display a map image including the travel route of the vehicle 1 of the vehicle ID “EV1” indicated by the location information stored in the map information storage part 225.

In the screen image 610 in FIG. 7, dashes “-” are marked in a group ID field and a group fraudulent use rate field which are associated with the user ID “USER0”. This shows that neither group ID nor estimation result in Step S6 is included in the information concerning an estimation result because the user of the user ID “USER0” does not belong to any group.

This enables the manager who sees the screen image 610 to grasp whether the vehicle 1 was fraudulently used by way of each user ID or not. For example, the manager who sees the screen image 610 in FIG. 7 can grasp that the vehicle 1 was fraudulently used by way of the user ID “USER 0” because the fraudulent use rate “86%” of the vehicle 1 of the vehicle ID “EV1” by the user of the user ID “USER0” in the use date and time “from 11:30 to 12:00 on Jan. 3, 2022” is equal to or higher than a predetermined threshold “80%”.

Further, the manager can grasp that the fraudulent use rate “82%” of the vehicle 1 of the vehicle ID “EV1” by the user of the user ID “USER1” in the use date and time “from 13:00 to 14:00 on Jan. 3, 2022” is equal to or higher than the predetermined threshold “80%”. However, the manager can also grasp that the group fraudulent use rate “20%” is equal to or lower than the predetermined threshold “80%”. Consequently, the manager can grasp that the vehicle 1 was fraudulently used by a user who belongs to the group of the group ID “GRP1” including the user of the user ID “USER1” but is other than the user of the user ID “USER1” by passing through the authentication using the user ID “USER1”.

Further, the manager can grasp that the fraudulent use rate “90%” of the vehicle 1 of the vehicle ID “EV1” by way of the user ID “USER1” in the date and time “from 14:30 to 15:00 on Jan. 3, 2022” is equal to or higher than the predetermined threshold “80%”. The manager can grasp that the group fraudulent use rate “86%” is also equal to or higher than the predetermined threshold “80%”. Consequently, the manager can grasp that the vehicle 1 was fraudulently used by a stranger who is other than the user of the user ID “USER1” and does not belong to the group of the group ID “GRP1” including the user by passing through the authentication using the user ID “USER1”.

The screen image 610 in FIG. 7 displays only the lowest one among the fraudulent use rates of the vehicle 1 of the vehicle ID by the users of the group who belong to the same group as the user of the user ID but are other than the user of the user ID in the group fraudulent use rate field associated with the user ID. However, the screen image 610 is not limited thereto, but may display a fraudulent use rate of the vehicle 1 of the vehicle ID by at least one user of the group among the users of the group other than the user of the user ID in the group fraudulent use rate field.

In this case, in the group fraudulent use rate field, fraudulent use rates of the vehicle 1 of the vehicle ID by the users of the group may be displayed, for example, as “GRPUSR1: 20%, GRPUSR2: 40%”, in association with the group user IDs of identifying the users of the group. Alternatively, only an average of fraudulent use rates of the vehicle 1 of the vehicle ID by the one or more users of the group may be displayed in the group fraudulent use rate field.

### Modifications

The present disclosure may adopt the following modifications.

(1) In the embodiment described above, the description is made about an exemplary estimation of a fraudulent use rate of a vehicle 1 by way of each user ID by using a fraudulent use rate estimation model corresponding to the user ID having learned a relationship between a use history of the storage battery 151 indicated by log data (hereinafter, learning log data) which is associated with the user ID and is stored in the log storage part 221 during the use of the vehicle 1 in a predetermined period and a use rate of the vehicle 1 by a user other than the authenticated user of the user ID. The predetermined period includes, for example, a one-month period from two months before to one month before a point in time at which the fraudulent use rate estimation model is created, or a one-month period until the point in time of the creation.

However, instead of the fraudulent use rate estimation model corresponding to each user ID, the estimation part 203 may use a first fraudulent use rate estimation model (first learned model) corresponding to each user ID and a second fraudulent use rate estimation model (second learned model) corresponding to each user ID to thereby estimate a fraudulent use rate of the vehicle 1 by way of the user ID.

The first fraudulent use rate estimation model corresponding to each user ID is a learned model having learned a relationship between a use history of the storage battery 151 indicated by log data specified by an acceleration of the vehicle 1 included in the learning log data and a use rate of the vehicle 1 by a user other than the authenticated user of the user ID.

The second fraudulent use rate estimation model corresponding to each user ID is a learned model having learned a relationship between a use history of the storage battery 151 indicated by log data specified by a deceleration of the vehicle 1 included in the learning log data and a use rate of the vehicle 1 by a user other than the authenticated user of the user ID. This modified configuration may be implemented, for example, in the following manner.

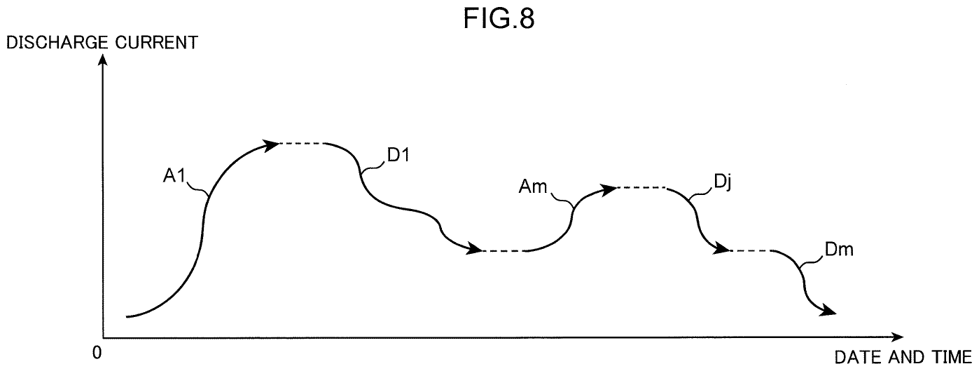

FIG. 8 is a graph showing an exemplary time-series change in discharge current indicated by log data. In FIG. 8, the horizontal axis shows date and times indicated by date and time information included in learning log data. The vertical axis indicates discharge current of the storage battery 151 included in the log data.

As shown in FIG. 8, the learning log data includes log data specified by a first time-series change A1, . . . Am which is a time-series change in the electric current discharged from the storage battery 151 in an acceleration of the vehicle 1 and log data specified by a second time-series change D1, . . . Dm which is a time-series change in the decrease electric current discharged from the storage battery 151 in a deceleration of the vehicle 1.

Accordingly, the learning part 200 performs a machine learning of a relationship between the first time-series change A1, . . . Am indicated by the learning log data and a use rate of the vehicle 1 by a user other than the user of the user ID in the same manner as the embodiment described above. A time-series change in the electric current discharged from the storage battery 151 indicated by the learning log data in an acceleration where a vehicle speed change is smaller than a predetermined per-hour-speed (e.g., 10 km/h) may not be used for the machine learning.

The learning part 200 performs this machine learning to thereby create a first fraudulent use rate estimation model corresponding to each user ID which outputs, in a case that log data specified by a first time-series change included in log data associated with the user ID is input thereto, a first fraudulent use rate of the vehicle 1 by way of the user ID. The learning part 200 stores the created first fraudulent use rate estimation model corresponding to each user ID in the model storage part 222.

In the same manner as the above, the learning part 200 performs a machine learning of a relationship between the second time-series change D1, . . . Dm indicated by the learning log data and a use rate of the vehicle 1 by a user other than the user of the user ID. In the same manner as the above, a time-series change in the decrease electric current discharged from the storage battery 151 indicated by the learning log data in a deceleration where a vehicle speed change is smaller than a predetermined per-hour-speed (e.g., 10 km/h) may not be used for the machine learning.

The learning part 200 performs this machine learning to thereby create a second fraudulent use rate estimation model corresponding to each user ID which outputs, in a case that log data specified by a second time-series change included in log data associated with the user ID is input thereto, a second fraudulent use rate of the vehicle 1 by way of the user ID. The learning part 200 stores the created second fraudulent use rate estimation model corresponding to each user ID in the model storage part 222.

In Step S3 (FIG. 6), the estimation part 203 inputs log data specified by the first time-series change among log data included in a target record group to a first fraudulent use rate estimation model corresponding to a user ID of a travel corresponding to the record group to thereby estimate a first fraudulent use rate of the vehicle 1 by way of the user ID.

Additionally, the estimation part 203 inputs log data specified by the second time-series change among the log data included in the target record group to a second fraudulent use rate estimation model corresponding to the user ID of the travel corresponding to the record group to thereby estimate a second fraudulent use rate of the vehicle 1 by way of the user ID.

Further, the estimation part 203 estimates a weighted average [=(first fraudulent use rate×α+second fraudulent use rate×β)/α+β] of the first fraudulent use rate of the vehicle 1 by way of the user ID and the second fraudulent use rate of the vehicle 1 by way of the user ID as a fraudulent use rate of the vehicle 1 by way of the user ID.

Similarly, in Step S6 (FIG. 6), the estimation part 203 estimates respective fraudulent use rates of the vehicle 1 by one or more users of the group other than the target user during the travel corresponding to the target record group using first and second fraudulent use rate estimation models corresponding to respective user IDs of the users of the group.

(2) Instead of the fraudulent use rate estimation model corresponding to each user ID described in the embodiment, the estimation part 203 may use a third fraudulent use rate estimation model (third learned model) corresponding to each user ID to thereby estimate a fraudulent use rate of the vehicle 1 by way of the user ID.

The third fraudulent use rate estimation model corresponding to each user ID is a learned model having learned a relationship among a use history of the storage battery 151 indicated by learning log data, a geographic feature of a travel route of the vehicle 1 in a period corresponding to the learning log data, and a use rate of the vehicle 1 by a user other than the authenticated user of the user ID. The configuration of this modification may be implemented, for example, in the following manner.

The learning part 200 acquires from the log storage part 221 location information associated with learning log data as information indicative of a travel route of the vehicle 1 in a period corresponding to the learning log data. The learning part 200 acquires from the map information storage part 225 information indicative of a geographic feature of the travel route of the vehicle 1 in the period corresponding to the learning log data indicated by the acquired location information.

The learning part 200 performs a machine learning by using a certain learning algorithm and treating a use history of the storage battery 151 indicated by the learning log data and the geographic feature of the travel route of the vehicle 1 in the period corresponding to the learning log data indicated by the information acquired from the map information storage part 225 as explanatory variables and a use rate of the vehicle 1 by a user other than the authenticated user of the user ID as a target variable.

The learning part 200 performs this machine learning to thereby create a third fraudulent use rate estimation model corresponding to each user ID which outputs, in a case that log data associated with the user ID and information (feature data) indicative of a geographic feature of a travel route of the vehicle 1 in a period corresponding to the log data are input thereto, a fraudulent use rate of the vehicle 1 by way of the user ID. The learning part 200 stores the created third fraudulent use rate estimation model corresponding to each user ID in the model storage part 222.

In Step S3 (FIG. 6), the estimation part 203 acquires from the map information storage part 225 information indicative of a geographic feature of a travel route of the vehicle 1 in a period corresponding to log data included in a target record group. Further, the estimation part 203 inputs the log data and the information indicative of the geographic feature of the travel route of the vehicle 1 in the period corresponding to the log data to a third fraudulent use rate estimation model corresponding to a user ID of a travel corresponding to the record group to thereby estimate a fraudulent use rate of the vehicle 1 by way of the user ID.

Similarly, in Step S6 (FIG. 6), the estimation part 203 estimates respective fraudulent use rates of the vehicle 1 by way of one or more users of the group other than the target user during the travel corresponding to the target record group using third fraudulent use rate estimation models corresponding to respective user IDs of the users of the group.

(3) Instead of the fraudulent use rate estimation model corresponding to each user ID described in the embodiment, the estimation part 203 may use a fourth fraudulent use rate estimation model (fourth learned model) corresponding to each user ID to thereby estimate a fraudulent use rate of the vehicle 1 by way of the user ID.

The fourth fraudulent use rate estimation model corresponding to each user ID is a learned model having learned a relationship among a use history of the storage battery 151 indicated by learning log data, a level of a traffic congestion occurred on a travel route of the vehicle 1 in a period corresponding to the learning log data, and a use rate of the vehicle 1 by a user other than the authenticated user of the user ID. The configuration of this modification can be implemented, for example, in the following manner.

The learning part 200 acquires location information associated with learning log data from the log storage part 221. The learning part 200 controls the communication part 21 to send information which requests information (hereinafter, traffic congestion information) indicating a level of a traffic congestion occurred at a location indicated by the location information associated with the learning log data at a date and time indicated by date and time information included in the learning log data to a non-illustrated public server which provides information concerning traffic congestions in various places. Accordingly, when the communication part 21 receives the traffic congestion information returned from the public server, the learning part 200 acquires the traffic congestion information.

The learning part 200 performs a machine learning by using a certain learning algorithm and treating a use history of the storage battery 151 indicated by the learning log data and a level of the traffic congestion occurred on a travel route of the vehicle 1 in a period corresponding to the learning log data indicated by the traffic congestion information acquired from the public server as explanatory variables and a use rate of the vehicle 1 by a user other than the authenticated user of the user ID as a target variable.

The learning part 200 performs this machine learning to thereby create a fourth fraudulent use rate estimation model corresponding to each user ID which outputs, in a case that log data associated with the user ID and information (traffic congestion data) indicative of a level of a traffic congestion occurred on a travel route of the vehicle 1 in a period corresponding to the log data are input thereto, a fraudulent use rate of the vehicle 1 by way of the user ID. The learning part 200 stores the created fourth fraudulent use rate estimation model corresponding to each user ID in the model storage part 222.

In Step S3 (FIG. 6), the estimation part 203 acquires, from the public server, the information indicative of the level of traffic congestion occurred on the travel route of the vehicle 1 in the period corresponding to the log data included in the target record group in the same manner as the above. Further, the estimation part 203 inputs the log data and the information acquired from the public server to the fourth fraudulent use rate estimation model corresponding to the user ID of the travel corresponding to the record group to thereby estimate a fraudulent use rate of the vehicle 1 by way of the user ID.

Similarly, in Step 6 (FIG. 6), the estimation part 203 estimates respective fraudulent use rates of the vehicle 1 by one or more users of the group other than the target user during the travel corresponding to the target record group using fourth fraudulent use rate estimation models corresponding to respective user IDs of the users of the group.

(4) Instead of the fraudulent use rate estimation model corresponding to each user ID described in the embodiment, the estimation part 203 may use a fifth fraudulent use rate estimation model (fifth learned model) corresponding to each user ID to thereby estimate a fraudulent use rate of the vehicle 1 by way of the user ID.

The fifth fraudulent use rate estimation model corresponding to each user ID is a learned model having learned a relationship among a use history of the storage battery 151 indicated by learning log data, a history (hereinafter, operation history) of an operation state of the vehicle 1 in a period corresponding to the learning log data, and a use rate of the vehicle 1 by a user other than the authenticated user of the user ID. The configuration of this modification can be implemented, for example, in the following manner.

The learning part 200 acquires from the log storage part 221 vehicle operation information associated with learning log data. The learning part 200 performs a machine learning by using a certain learning algorithm and treating a use history of the storage battery 151 indicated by learning log data and an operation history of the vehicle 1 in a period corresponding to the learning log data indicated by the vehicle operation information as explanatory variables and a use rate of the vehicle 1 by a user other than the authenticated user of the user ID as a target variable.

The learning part 200 performs this machine learning to thereby create a fifth fraudulent use rate estimation model corresponding to each user ID which outputs, in a case that log data associated with the user ID and information (operation log data) indicative of the operation history of the vehicle 1 in the period corresponding to the log data are input thereto, a fraudulent use rate of the vehicle 1 by way of the user ID. The learning part 200 stores the created fifth fraudulent use rate estimation model corresponding to each user ID in the model storage part 222.

In Step S3 (FIG. 6), the estimation part 203 acquires vehicle operation information included in a target record group. Further, the estimation part 203 inputs log data included in the target record group and the vehicle operation information to a fifth fraudulent use rate estimation model corresponding to the user ID of a travel corresponding to the record group to thereby estimate a fraudulent use rate of the vehicle 1 by way of the user ID.

Similarly, in Step 6 (FIG. 6), the estimation part 203 estimates respective fraudulent use rates of the vehicle 1 by one or more users of the group other than the target user during the travel corresponding to the target record group using fifth fraudulent use rate estimation models corresponding to respective user IDs of the users of the group.

(5) The estimation part 203 may estimate a fraudulent use rate of the vehicle 1 by way of each user ID on the basis of log data specified by a first time-series change A1, . . . Am (FIG. 8) stored in the log storage part 221 in association with the user ID without using any fraudulent use rate estimation model corresponding to the user ID described above in the embodiment and modifications. As described above, the first time-series change A1, . . . Am (FIG. 8) indicates a time-series change in the electric current discharged from the storage battery 151 in an acceleration of the vehicle 1. The configuration of this modification may be implemented, for example, in the following manner.

The estimation part 203 calculates a reference average and a reference standard deviation which are used for estimation of the fraudulent use rate by way of each user ID at a desired time, e.g., once a month or at a time immediately before a fraudulent use rate estimation process (FIG. 6).

Specifically, the estimation part 203 acquires pieces of log data specified by first time-series changes A1, . . . Am (FIG. 8) in a predetermined number of latest cases (e.g., 10,000 cases) among the log data stored in association with each user ID from the log storage part 221.

The estimation part 203 equally divides a period (hereinafter, an acceleration period) from a start point to an end point of the acceleration of the vehicle 1 represented by each first time-series change A1, . . . Am (FIG. 8) into a certain number (e.g., ten) of segments (hereinafter, time segments). The way of dividing the acceleration period into a certain number of time segments by the estimation part 203 is not limited to an equal segmentation, but the period may be divided, for example, in such a manner that the nearer a time segment is to the start point of the acceleration the shorter the time segment is. Hereinafter, the number of time segments (certain number) is called as the number of time segments.

The estimation part 203 checks the pieces of log data specified by the first time-series changes A1, . . . Am (FIG. 8) in the predetermined number of cases and calculates an average and a standard deviation of the electric current discharged from the storage battery 151 in each of the time segments in order of proximity of time segments to the start point of the acceleration of the vehicle 1. The estimation part 203 stores in the memory 22 the calculated averages as respective reference averages in the time segments. The estimation part 203 stores in the memory 22 the calculated standard deviations as respective reference standard deviations in the time segments.

Hereinafter, a specific example of calculation of a reference average and a reference standard deviation in each of the time segments will be described. For convenience of explanation, the predetermined number of cases are two cases, and the number of time segments is two. In this example, the estimation part 203 calculates an average of the electric current discharged from the storage battery 151 in a first time segment nearest to the start point of the acceleration of the vehicle 1 specified by a first-first time-series change. Similarly, the estimation part 203 calculates an average of the electric current discharged from the storage battery 151 in the first time segment nearest to the start point of the acceleration of the vehicle 1 specified by a second-first time-series change. The estimation part 203 calculates an average of the two averages as a reference average in the first time segment. Similarly, the estimation part 203 calculates a reference average in a second time segment which is the second nearest to the start point of the acceleration of the vehicle 1.

Further, the estimation part 203 calculates a standard deviation of the electric current discharged from the storage battery 151 in the first time segment specified by the first-first time-series change. Similarly, the estimation part 203 calculates a standard deviation of the electric current discharged from the storage battery 151 in the first time segment specified by the second-first time-series change. Thereafter, the estimation part 203 calculates an average of the two standard deviations as a reference standard deviation in the first time segment. Similarly, the estimation part 203 calculates a reference standard deviation in the second time segment which is the second nearest to the start point of the acceleration of the vehicle 1.

Further, in the fraudulent use rate estimation process (FIG. 6), in Step S1, the estimation part 203 acquires record groups having date and times indicated by date and time information falling within a predetermined period from the log storage part 221 in the same manner as in the embodiment described above. The predetermined period includes a period from an end of a previous fraudulent use rate estimation process to a start of the current fraudulent use rate estimation process.

Next, in Step S2 of this modification, the estimation part 203 acquires, among the record groups acquired in Step S1, a piece of log data specified by the latest first time-series change in the acceleration of the vehicle 1.

In Step S3 of this modification, the estimation part 203 divides the period from the start point to the end point of the acceleration of the vehicle 1 represented by the piece of log data acquired in Step S2 into the number of time segments (hereinafter, target time segments), and calculates an average of the electric current discharged from the storage battery 151 in each of the target time segments.

The estimation part 203 performs the following determination process about each target time segment and each set of time segments in order of proximity of target time segments and sets of time segments to the start point of the acceleration of the vehicle 1 until the target time segment and the set of time segments nearest to the end point of the acceleration of the vehicle 1.

The estimation part 203 calculates a difference (hereinafter, average difference) between an average of the electric current discharged from the storage battery 151 in a target time segment Tk which is the k-th nearest (where k denotes an integer between 1 and the number of time segments) to the start point of the acceleration of the vehicle 1 and a reference average in a time segment DTk which is the k-th nearest to the start point of the acceleration of the vehicle 1 stored in the memory 22. The estimation part 203 determines whether the average difference is greater than a standard error which is a product of a reference standard deviation in the time segment DTk stored in the memory 22 and a predetermined coefficient (e.g., 1.0).

Further, the estimation part 203 calculates, as a fraudulent use rate of the vehicle 1 by way of each user ID, a result (=number of irregular accelerations×100 (%)/number of time segments) which is obtained by dividing, by the number of time segments, a product of the number (hereinafter, number of irregular accelerations) of average differences determined to be greater than standard errors and “100 (%)”.

Hereinafter, a specific example of calculation of a fraudulent use rate of the vehicle 1 by way of each user ID will be described. For convenience of explanation, in the same manner as the specific example of calculation of the reference average and the reference standard deviation in each of the time segments, the predetermined number of cases are two cases, and the number of time segments is two. Further, the memory 22 stores reference averages and reference standard deviations in first and second time segments, respectively.

In this example, in Step S3 of this modification, the estimation part 203 checks the piece of log data specified by the latest first time-series change in the acceleration of the vehicle 1 acquired in Step S2 of this modification, and divides the acceleration period of the vehicle 1 specified by the first time-series change into two target time segments. The estimation part 203 calculates an average of the electric current discharged from the storage battery 151 in the first target time segment which is the nearest to the start point of the acceleration of the vehicle 1 and an average of the electric current discharged from the storage battery 151 in a second target time segment which is the second nearest to the start point of the acceleration of the vehicle 1.

Further, the estimation part 203 determines whether an average difference, i.e., a difference between the average of the electric current discharged from the storage battery 151 in a target time segment T1 which is the first nearest to the start point of the acceleration of the vehicle 1 and a reference average in a time segment DT1 which is the first nearest to the start point of the acceleration of the vehicle 1 stored in the memory 22, is greater than a standard error which is a product of a reference standard deviation in the time segment DT1 stored in the memory 22 and a predetermined coefficient (e.g., 1.0).

Similarly, the estimation part 203 determines whether an average difference, i.e., a difference between an average of the electric current discharged from the storage battery 151 in a target time segment T2 which is the second nearest to the start point of the acceleration of the vehicle 1 and a reference average in a time segment DT2 which is the second nearest to the start point of the acceleration of the vehicle 1 stored in the memory 22, is greater than a standard error which is a product of a reference standard deviation in the time segment DT2 stored in the memory 22 and a predetermined coefficient (e.g., 1.0).

In a case that the average difference is determined to be greater than the standard error in one of two determinations, the estimation part 203 calculates, as a fraudulent use rate of the vehicle 1 by way of each user ID, a result “50%” (=1×100 (%)/2) which is obtained by dividing, by the number “2” of time segments, a product of the number “1” of irregular accelerations, whose average difference is determined to be greater than the standard error, and “100 (%)”.

In Step S2 of this modification, the estimation part 203 may acquire not only the piece of log data specified by the latest first time-series change in the acceleration of the vehicle 1 but also pieces of log data specified by all the first time-series changes from the record group acquired in Step S1. Accordingly, the estimation part 203 may perform Step S3 of this modification using respective pieces of log data specified by the first time-series changes acquired in this Step S2. In this case, the estimation part 203 may calculate an average of the fraudulent use rates of the vehicle 1 by way of each user ID calculated in the respective Steps S3 as a fraudulent use rate of the vehicle 1 by way of the user ID.

Further, in the same manner as the above, the estimation part 203 may estimate a fraudulent use rate of the vehicle 1 by way of each user ID on the basis of log data specified by a second time-series change D1, . . . Dm (FIG. 8) stored in the log storage part 221 in association with the user ID. As described above, the second time-series change D1, . . . Dm (FIG. 8) indicates a time-series change in the decrease electric current discharged from the storage battery 151 in a deceleration of the vehicle 1.

In this case, the estimation part 203 acquires pieces of log data specified by second time-series changes D1, . . . Dm (FIG. 8) in a predetermined number of latest cases (e.g., 10,000 cases) among the log data stored in association with each user ID from the log storage part 221, and equally divides a period (hereinafter, a deceleration period) from a start point to an end point of a deceleration of the vehicle 1 represented by each second time-series change D1, . . . Dm (FIG. 8) into a certain number (e.g., ten) of time segments. Further, the estimation part 203 checks the pieces of log data specified by the second time-series changes D1, . . . Dm (FIG. 8) in the predetermined number of cases and calculates an average and a standard deviation of the decrease electric current discharged from the storage battery 151 in each of the time segments in order of proximity of time segments to the start point of the deceleration of the vehicle 1 as a reference average and a reference standard deviation in each of the time segments, and stores them in the memory 22.

In Step S2 of the fraudulent use rate estimation process (FIG. 6), the estimation part 203 acquires, among the record groups acquired in Step S1, a piece of log data specified by the latest second time-series change in the deceleration of the vehicle 1. In Step S3, the estimation part 203 divides the period from the start point to the end point of the deceleration of the vehicle 1 represented by the piece of log data acquired in Step S2 into the above-mentioned number of target time segments, and calculates an average of the decrease electric current discharged from the storage battery 151 in each of the target time segments.

The estimation part 203 performs the following determination process about each target time segment and each set of time segments in order of proximity of target time segments and sets of time segments to the start point of the deceleration of the vehicle 1 until the target time segment and the set of time segments nearest to the end point of the deceleration of the vehicle 1.

The estimation part 203 calculates an average difference, i.e., a difference between an average of the decrease electric current discharged from the storage battery 151 in a target time segment Tk which is the k-th nearest (where k denotes an integer between 1 and the number of time segments) to the start point of the deceleration of the vehicle 1 and a reference average in a time segment DTk which is the k-th nearest to the start point of the deceleration of the vehicle 1 stored in the memory 22. The estimation part 203 determines whether the calculated average difference is greater than a standard error which is a product of a reference standard deviation in the time segment DTk stored in the memory 22 and a predetermined coefficient (e.g., 1.0). Further, the estimation part 203 calculates, as a fraudulent use rate of the vehicle 1 by way of each user ID, a result (=number of irregular decelerations×100 (%)/number of time segments) which is obtained by dividing, by the number of time segments, a product of the number (hereinafter, number of irregular decelerations) of average differences determined to be greater than standard errors and “100 (%)”.

In Step S2, the estimation part 203 may acquire not only the piece of log data specified by the latest second time-series change in the deceleration of the vehicle 1 but also pieces of log data specified by all the second time-series changes from the record group acquired in Step S1. Accordingly, the estimation part 203 may perform Step S3 of this modification using respective pieces of log data specified by the second time-series changes acquired in this Step S2. In this case, the estimation part 203 may calculate an average of the fraudulent use rates of the vehicle 1 by way of each user ID calculated in the respective Steps S3 as a fraudulent use rate of the vehicle 1 by way of the user ID.

(6) The information concerning an estimation result by the estimation part 203 may be displayed on an information terminal 6 used by a user of the vehicle 1. The configuration of this modification may be implemented, for example, in the following manner.

After an end of a fraudulent use rate estimation process, the output part 204 sequentially collates fraudulent use rates of the vehicle 1 by way of user ID during the respective travels in the vehicle 1 included in the information concerning an estimation result stored in the estimation result storage part 224.

In a case that the collated fraudulent use rate of the vehicle 1 by way of the user ID during the travel of the vehicle 1 is equal to or higher than a predetermined threshold, the output part 204 outputs information indicative of a fraudulent use of the vehicle 1 to an information terminal (second information terminal) 6 used by the authenticated user of the user ID.

Specifically, the output part 204 controls the communication part 21 to send the information concerning an estimation result to contact information of the authenticated user of the user ID included in the information concerning an estimation result.

In a case that the communication part 63 in the information terminal 6 used by the authenticated user of the user ID thus receives the information concerning an estimation result from the server 2, and thereafter, the operation part 62 receives an operation of launching an application corresponding to the contact information of the authenticated user by the authenticated user, or alternatively, the application is already launched, the processor 60 controls the display part 61 to display a screen image of the application including the information concerning an estimation result received by the communication part 63.

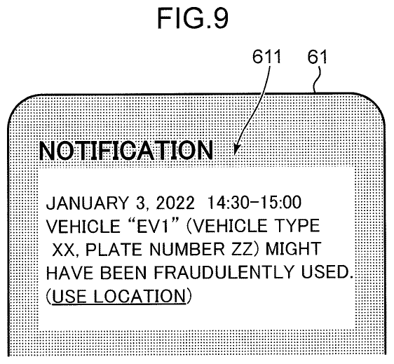

FIG. 9 is an illustration showing a second exemplary output of the fraudulent use rate of the vehicle 1. For example, in a case that the contact information of the authenticated user is an account of a social networking service, a screen image 611 of an application of the social networking service shown in FIG. 9 is displayed. The screen image 611 shown in FIG. 9 is displayed in the case that a result of the estimation of the fraudulent use rate of the vehicle 1 by way of the user ID of the authenticated user of the information terminal 6 is equal to or higher than a predetermined threshold during a travel in the vehicle 1 of the vehicle ID “EV1” in the period “from 14:30 to 15:00 on Jan. 3, 2022”.

Specifically, a message is displayed on the screen image 611 which indicates that the vehicle 1 of the vehicle ID “EV1”, of the vehicle type “XX” and the plate number “ZZ” which are shown by the vehicle information included in the information concerning an estimation result might have been fraudulently used in the period “from 14:30 to 15:00 on Jan. 3, 2022” indicated by the use date and time information included in the information concerning an estimation result.

Further, a hyperlink to location information indicative of a travel route of the vehicle 1 of the vehicle ID “EV1” in the period indicated by the use date and time information included in the information concerning an estimation result is displayed below the message. When the hyperlink is clicked, the processor 60 controls the display part 61 to further display a map image including the travel route of the vehicle 1 of the vehicle ID “EV1” indicated by the location information stored in the map information storage part 225.

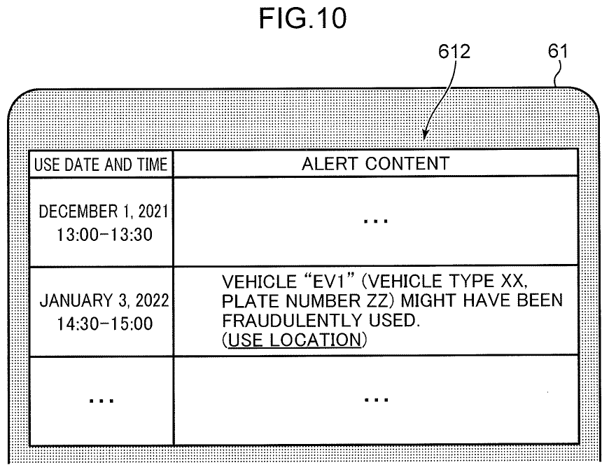

FIG. 10 is an illustration showing a third exemplary output of the fraudulent use rate of the vehicle 1. For example, in a case that the contact information of the user includes an IP address of an information terminal 6, a screen image 612 of an alert notifying application shown in FIG. 10 is displayed. The screen image 612 shown in FIG. 10 is displayed in the case that a result of the estimation of the fraudulent use rate of the vehicle 1 by way of the user ID of the authenticated user of the information terminal 6 is equal to or higher than a predetermined threshold during the travel in the vehicle 1 of the vehicle ID “EV1” in the period “from 14:30 to 15:00 on Jan. 3, 2022”.

Specifically, in a use date and time field, the period “from 14:30 to 15:00 on Jan. 3, 2022” indicated by the use date and time information included in the information concerning an estimation result is shown. In an alert detail field, the message is displayed which indicates that the vehicle 1 of the vehicle ID “EV1”, of the vehicle type “XX” and the plate number “ZZ” which are shown by the vehicle information included in the information concerning an estimation result might have been fraudulently used.

Further, the hyperlink to the location information indicative of the travel route of the vehicle 1 of the vehicle ID “EV1” in the period indicated by the use date and time information included in the information concerning an estimation result is displayed below the message. When the hyperlink is clicked, the processor 60 controls the display part 61 to further display the map image including the travel route of the vehicle 1 of the vehicle ID “EV1” indicated by the location information stored in the map information storage part 225.

In a case that the contact information of the user includes an e-mail address, the output part 204 controls the communication part 21 to send an e-mail containing the information concerning an estimation result to the e-mail address. In this case, if the user performs an operation of launching an e-mail application in the information terminal 6 and further performs an operation of reading a content of the e-mail, the processor 60 controls the display part 61 to display the content of the e-mail.

(7) In the embodiment and the modifications described above, examples in which a single vehicle 1 is managed by the information processing system 1000 are described. However, the information processing system 1000 may manage a plurality of vehicles 1. In this case, the fraudulent use rate estimation process (FIG. 6) may be performed by treating each of the vehicles 1 as the target. Further, various fraudulent use rate estimation models may be created for each vehicle 1 using use histories of a storage battery 151 included in each of the vehicles 1, and may be stored in the model storage part 222. Further, in Step S3 (FIG. 6) and Step S6 (FIG. 6), various fraudulent use rate estimation models for the target vehicle 1 of the fraudulent use rate estimation process (FIG. 6) may be used.

Since the techniques according to the present disclosure enables an early detection of a user subjected to a fraudulent use of an electric mover, the techniques are useful in reducing damages which the user subjected to the fraudulent use of the electric mover suffers.

1. An information processing method for detecting a fraudulent use of an electric mover driven by an electric power of a battery, by a computer, comprising:
acquiring a user ID proving a user to be an authenticated user for the electric mover and log data indicative of a use history of the battery associated with the user ID;
estimating on the basis of the log data a fraudulent use rate of the electric mover by way of the user ID; and
outputting a result of the estimation.

2. The information processing method according to claim 1, wherein
the use history of the battery includes at least one of a first time-series change indicating a time-series change in the electric current discharged from the battery in an acceleration of the electric mover and a second time-series change indicating a time-series change in the decrease electric current discharged from the battery in a deceleration of the electric mover.

3. The information processing method according to claim 1, wherein,
in the estimation of the fraudulent use rate of the electric mover, the fraudulent use rate of the electric mover by way of the user ID is estimated by inputting the log data to a learned model having learned a relationship between the use history of the battery and a use rate of the electric mover by a user other than the authenticated user of the user ID.

4. The information processing method according to claim 2, wherein,
in the estimation of the fraudulent use rate of the electric mover, the fraudulent use rate of the electric mover by way of the user ID is estimated on the basis of an average of the electric current in a predetermined period specified by the first time-series change included in the log data.

5. The information processing method according to claim 2, wherein,
in the estimation of the fraudulent use rate of the electric mover, the fraudulent use rate of the electric mover by way of the user ID is estimated on the basis of an average of the decrease electric current in a predetermined period specified by the second time-series change included in the log data.

6. The information processing method according to claim 2, wherein,
in the estimation of the fraudulent use rate of the electric mover, in a case that the use history of the battery includes the first time-series change, a first fraudulent use rate of the electric mover by way of the user ID is estimated by inputting data specifying the first time-series change included in the log data to a first learned model having learned a relationship between the first time-series change and a use rate of the electric mover by a user other than the authenticated user of the user ID,
in a case that the use history of the battery includes the second time-series change, a second fraudulent use rate of the electric mover by way of the user ID is estimated by inputting data specifying the second time-series change included in the log data to a second learned model having learned a relationship between the second time-series change and a use rate of the electric mover by a user other than the authenticated user of the user ID, and
a weighted average of the first fraudulent use rate and the second fraudulent use rate is estimated as the fraudulent use rate of the electric mover by way of the user ID.

7. The information processing method according to claim 1, further comprising:
acquiring feature data indicating a geographic feature of a travel route of the electric mover in a period corresponding to the use history of the battery indicated by the log data, wherein,
in the estimation of the fraudulent use rate of the electric mover, the fraudulent use rate of the electric mover by way of the user ID is estimated by inputting the log data and the feature data to a third learned model having learned a relationship among the use history of the battery, the geographic feature of the travel route of the electric mover in the period corresponding to the use history, and a use rate of the electric mover by a user other than the authenticated user of the user ID.

8. The information processing method according to claim 7, wherein
the geographic feature includes at least one of a speed limit and a road width.

9. The information processing method according to claim 1, further comprising:
acquiring traffic congestion data indicative of a level of a traffic congestion occurred on a travel route of the electric mover in a period corresponding to the use history of the battery indicated by the log data, wherein,
in the estimation of the fraudulent use rate of the electric mover, the fraudulent use rate of the electric mover by way of the user ID is estimated by inputting the log data and the traffic congestion data to a fourth learned model having learned a relationship among the use history of the battery, the level of the traffic congestion occurred on the travel route of the electric mover in the period corresponding to the use history, and a use rate of the electric mover by a user other than the authenticated user of the user ID.

10. The information processing method according to claim 1, further comprising:
acquiring operation log data indicative of an operation history of the electric mover in a period corresponding to the use history of the battery indicated by the log data, wherein,
in the estimation of the fraudulent use rate of the electric mover, the fraudulent use rate of the electric mover by way of the user ID is estimated by inputting the log data and the operation log data to a fifth learned model having learned a relationship among the use history of the battery, the operation history of the electric mover in the period corresponding to the use history, and a use rate of the electric mover by a user other than the authenticated user of the user ID.

11. The information processing method according to claim 10, wherein
the operation history of the electric mover includes at least one of histories of an accelerating operation, a steering operation, a braking operation, a travel speed, an acceleration, and an angular velocity.

12. The information processing method according to claim 1, wherein,
in the output of the result of the estimation, the user ID and the estimated fraudulent use rate of the electric mover by way of the user ID are output in association with each other to a first information terminal used by a manager of the electric mover.

13. The information processing method according to claim 12, further comprising:
estimating, in a case that the estimated fraudulent use rate of the electric mover by way of the user ID is equal to or higher than a predetermined threshold and the authenticated user of the user ID belongs to a group including a plurality of users, a fraudulent use rate of the electric mover by each of one or more users who belong to the group but are other than the authenticated user of the user ID by inputting the log data to a sixth learned model having learned a relationship between the use history of the battery and a use rate of the electric mover by a user different from the users of the group, wherein,
in the output of the result of the estimation, at least one of the fraudulent use rates of the electric mover by the one or more users of the group is further output in association with the user ID.

14. The information processing method according to claim 13, wherein,
in the output of the result of the estimation, a lowest one among the fraudulent use rates of the electric mover by the one or more users of the group is output in association with the user ID.

15. The information processing method according to claim 1, wherein,
in the output of the result of the estimation, in a case that the estimated fraudulent use rate of the electric mover by way of the user ID is equal to or higher than a predetermined threshold, information indicative of a fraudulent use of the electric mover is output to a second information terminal used by the authenticated user of the user ID.

16. An information processing device for detecting a fraudulent use of an electric mover driven by an electric power of a battery, comprising:
an acquisition part that acquires a user ID proving a user to be an authenticated user for the electric mover and log data indicative of a use history of the battery associated with the user ID;
an estimation part that estimates on the basis of the log data a fraudulent use rate of the electric mover by way of the user ID; and
an output part that outputs a result of the estimation.

17. A non-transitory computer readable storage medium storing a control program of an information processing device for detecting a fraudulent use of an electric mover driven by an electric power of a battery, the control program causing a computer included in the information processing device to function as:
an acquisition part that acquires a user ID proving a user to be an authenticated user for the electric mover and log data indicative of a use history of the battery associated with the user ID;
an estimation part that estimates on the basis of the log data a fraudulent use rate of the electric mover by way of the user ID; and
an output part that outputs a result of the estimation.
